(19) United States
(12) Patent Application Publication
(10) Pub. No.: US 2007/0136101 A1
(43) Pub. Date: Jun. 14, 2007

(54) IMAGE TRANSFER DEVICE, AN IMAGE DIAGNOSTIC DEVICE EQUIPPED WITH THE SAME, AN IMAGE MANAGEMENT SERVER, AND AN IMAGE DISPLAY DEVICE

(75) Inventor: Yasuto Hayatsu, Otawara-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 11/562,868

(22) Filed: Nov. 22, 2006

(30) Foreign Application Priority Data
Nov. 22, 2005 (JP) 2005-337162

(51) Int. Cl. G06F 19/00; G06K 9/00

(52) U.S. Cl. 705/3; 382/128

(57) ABSTRACT

Instructions are issued for transfer or recording of medical images to other devices on a network or recording to media such as movable storage media, the historical information regarding the transfer or recording corresponding to the instructional content of a transfer or recording is attached, and the medical image with historical information attached is transferred to other media. Therefore, in the event that a medical image is leaked, the route of leakage may be identified easily by analyzing the historical information of the leaked medical image, and prompt handling including setting up recurrence prevention measures can be determined.

### BACKGROUND OF THE INVENTION

1. Field of the Invention

The present invention relates to the art of transferring or recording images to other devices or to movable media, and particularly relates to the art of easily identifying the route of leakage in the event that images are passed around to other devices or movable media that has been leaked.

2. Description of the Related Art

In general, computers have the function of recording the status of use in logs, and saving such for a certain period of time (e.g., cf. “Japanese Patent Laid-open No. Hei 6-324779”). Logs recorded for ascertaining the status of use are, for example, the account of users who have logged in, the device name or IP address that has logged into a network, the name of a reference file, the details of the process that the computer has performed, and whether log-in and/or the process succeeded or failed, and so forth. This log is analyzed to find errors or unauthorized access to the computer, so it becomes evidence in the event of an audit and may be used as reference for setting recurrence prevention measures. In the analysis of unauthorized access, logs are used to identify the existence/nonexistence or scope of a leak, the existence/nonexistence or extent of modification, and the intrusion route.

Furthermore, in a network set up within a hospital, logs regarding the status of use are collected for each device connected to the network, including image diagnostic devices, image management servers, and image display devices. Medical images handled in hospitals are particularly important personal information. When medical images are leaked, the matter must be dealt with immediately.

However, hospitals possess an extremely large number of medical images, depending on the size of the facility. The medical images therein are transferred daily to each computer within the hospital through a network for medical services. When files such as medical images are leaked, the logs of all computers on the network must be analyzed in order to track down the route of leakage, and work to identify the scope of leaked medical images must be conducted. The larger the network within a hospital, the larger the volume of such work becomes. Therefore, at present, it is difficult to immediately identify the route of leakage, pursuing responsibilities based on leaked facts, and identifying the scope of leaked medical images or the like.

### SUMMARY OF THE INVENTION

The purpose of the present invention relates to the art of transferring or recording data files to other devices or movable storage media and particularly providing a method to easily identify the route of leakage when roaming data files are leaked.

In a device related to the present invention intended to achieve said purpose, historical information of a transfer or recording corresponding to the instructional content of a transfer or recording of medical images to be transferred or recorded is attached, when instructions for the transfer or recording of a medical image to other media are issued, a medical image with attached said historical information is transferred or recorded to other media.

According to embodiments of the present invention, when the leak of a medical image is found, persons in charge of security can easily identify the route of leakage by analyzing the historical information of a leaked medical image, and it is possible to pursue one's responsibility based on the leaked facts, and deal with identifying the scope of leaked medical images, or the like and to set up measures against recurrence.

### BRIEF DESCRIPTION OF THE DRAWINGS

FIG. 1 shows the constitution of an image transfer device related to the present embodiment.

FIG. 2 shows the data structure of a medical image handled in an image transfer device related to the present embodiment.

FIG. 3 shows transfer historical information to be attached to a medical image.

FIG. 4 is a flow chart showing the transfer process for an image transfer device.

FIG. 5 shows one example of a network within a hospital where an image transfer device according to the present embodiment is implemented.

FIG. 6 shows an image diagnostic device comprising the image transfer device of the present embodiment.

FIG. 7 shows an image management server comprising the image transfer device of the present embodiment.

FIG. 8 shows an image display device comprising the image transfer device of the present embodiment.

FIG. 9 shows the data structure of a medical image stored on an image management server.

FIG. 10 shows the data structure of a medical image transferred to an image display device.

FIG. 11 shows the data structure of a medical image output to movable storage media.

### DETAILED DESCRIPTION OF THE EMBODIMENT

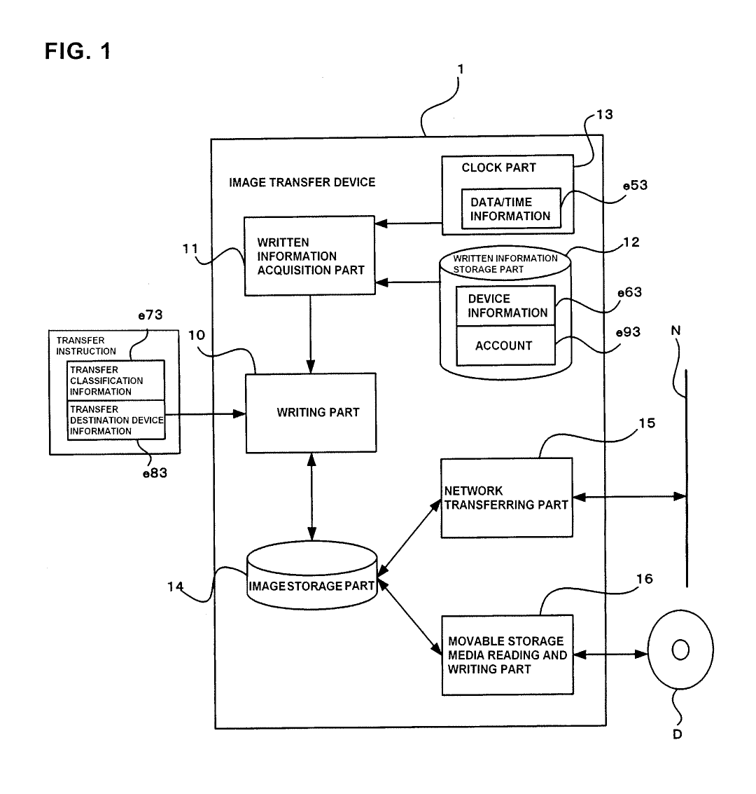

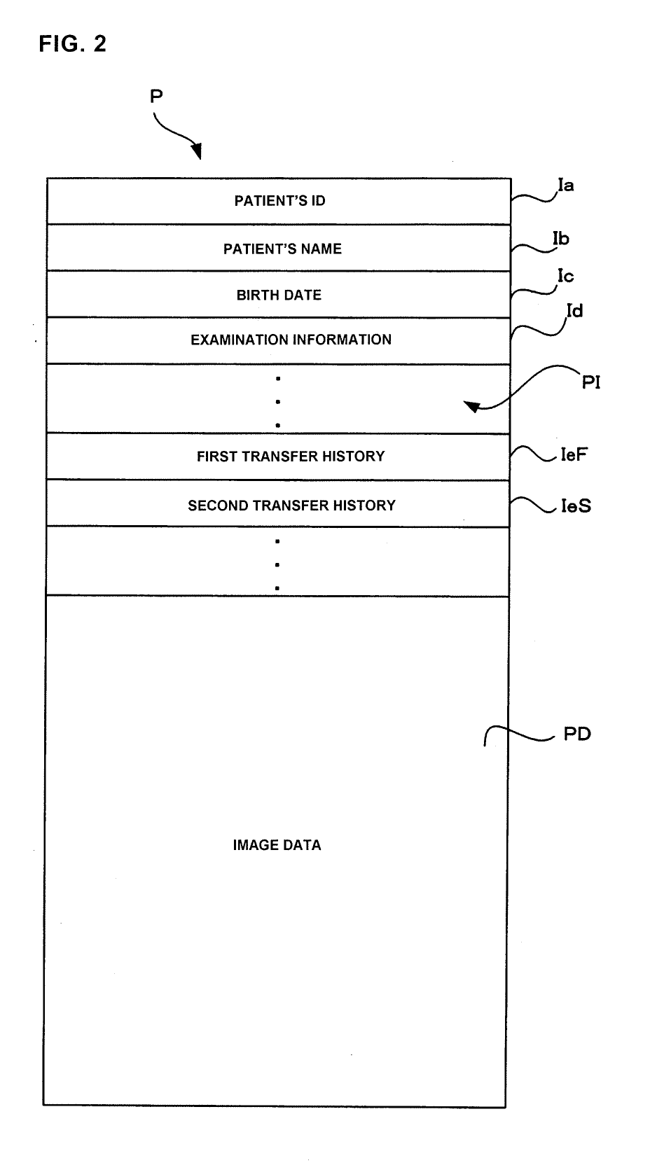

Hereinafter, referring to FIG. 1 through FIG. 11, embodiments related to the present invention will be described in detail. FIG. 1 is a figure showing the constitution of an image transfer device 1 related to the present embodiment. FIG. 2 is a figure illustrating the data structure of a medical image P to be handled in the image transfer device 1 related to the present embodiment.

The image transfer device 1 of the present embodiment transfers or records (hereinafter simply referred to as “transfer”) a medical image P to other media such as movable storage media D or other devices capable of data communication connected to a network N. To the medical image P to be transferred, transfer historical information IeF, IeS, and so forth (hereinafter simply referred to as “Ie” if the transfer historical information is not specifically distinguished) is automatically attached prior to the transfer.

Other media for transfer storage include various types of devices capable of data communication when connected to a hospital network. For example, image diagnostic devices such as X-ray diagnostic devices, CT devices, MRI devices, and supersonic diagnostic devices, and devices for managing, processing, and displaying medical images such as image management servers constituting PACS, image display devices, and so forth. Image display devices include reproducing equipment such as DVD players for domestic or commercial use. Furthermore, other media for transfer storage includes movable storage media D. Movable storage media D include magnetic media, optical storage media, semiconductor storage media, or the like having a shape and size that facilitates portability, such as floppy disks®, hard disks, CD-ROM, DVD-RAM, MO, and USB memory.

The medical image P is an image data within the subject to be examined that has been obtained using an image diagnostic device such as an X-ray diagnostic device, CT device, MRI device, or supersonic diagnostic device. The medical image P has a data structure comprising an image data PD as the data body with incidental information PI attached. The incidental information PI is information showing attributes of the medical image P. Attached incidental information PI showing the attributes of a medical image P may include the patient's ID number Ia, patient's name Ib, patient's birth date Ic, examination information Id regarding examinations performed on the patient, and transfer historical information Ie, or the like.

The transfer historical information Ie is a record of processed content or processing status related to transfer (or recording) processes of the image transfer device 1. With the image transfer device 1, this transfer historical information Ie may be attached as incidental information PI for a medical image P along with information showing the attributes of the medical image P, such as the patients' names Ib. The transfer historical information Ie is added every time a medical image P is transferred. For example, an image transfer device 1 from which a medical image P was originally created attaches the first transfer historical information IeF to the medical image P to be transferred, when transferring the created medical image P to another device. The image transfer device 1 provided with the device to which the transfer was made transfers the received medical image P further to another device, or additionally attaches transfer historical information IeS for the second time to a medical image P to be transferred.

The image transfer device 1 for transferring transfer historical information Ie that is made to be attached to a medical image P comprises a computer constituted of an operation control part (CPU), main storage part (RAM), external storage part (HDD), communication interface card (NIC), or a movable storage media reading and writing device, such as DVD drive or the like. By rolling out a program stored in the external storage part to the main storage part to decode and execute the program in the operation control part, and by the communication interface card or a movable storage media reading and writing device made to be driven following the execution, the attaching process of transfer historical information Ie and the transfer process of the medical image P to other media are conducted.

As a program is decoded and executed, logically and physically the image transfer device 1 comprises a writing part 10, a written information acquisition part 11, a written information storage part 12, a clock part 13, an image storage part 14, a network transferring part 15, and a movable storage media reading and writing part 16.

The writing part 10 is constituted including an operation processing part and a main storage part. When instructions for a transfer process are issued from an operator of the device, this writing part 10 attaches transfer historical information Ie related to the transfer instruction to a medical image P by writing in the incidental information IP. If past transfer historical information Ie has been attached to a medical image P, transfer historical information Ie related to the transfer instruction is added. The transfer instruction from an operator of the device is sent out from an input device connected to the image transfer device 1 or from a client device connected to the network N.

The image storage part 14 is constituted including a main storage part or an external storage part. This image storage part 14 stores plural medical images P including a medical image P instructed to be transferred. The storage contains both: those held by devices including an image transfer device 1 and those temporarily rolled out to a main storage part or an external storage part.

The written information storage part 12 is constituted including a main storage part or an external storage part. In this written information storage part 12, among transfer historical information Ie to be attached, information to identify the image transfer device 1 or information showing the user are stored. When the image transfer device 1 is functioning as a server, in place of information for identifying the image transfer device 1, information for identifying a client device logged into the image transfer device 1 is stored in the written information storage 12. Such information manages device information e63 that identifies the device being operated by an operator such as an image transfer device 1, or a client device that is logged in, and the account e93 of the operator of the device, who has logged into the image transfer device 1 directly or through a network N.

The clock part 13 comprises a clock IC provided with the image transfer device 1 for timing a date and a time.

The written information acquisition part 11 is constituted including an operation processing part and a main storage part. This written information acquisition part 11 acquires information to be written as transfer historical information Ie from the written information storage part 12 and the clock part 13. That is, the operating device information e63 and the account e93 are acquired from the written information storage part 12 and the date/time is acquired from the clock part 13 as operation date/time information e53.

The network transferring part 15 is constituted including a communication interface card. This network transferring part 15 transfers a medical image P attached with transfer historical information Ie to other devices through the network N. Moreover, from the client device, the account e93 to log into the image transfer device 1, the operating device information e63, and further, transfer instructions, or the like are sent. The transfer instructions include transfer classification information e73 showing a transferring method, or transfer destination device information e83. The transfer classification information e73 or the transfer destination device information e83 are written into the incidental information P1 by the writing part 11 as transfer historical information Ie along with the operating device information e63, the account e93, or the operation date/time information e53, to be attached to the medical image P.

The movable storage media reading and writing part 16 outputs a medical image P to an inserted movable storage media D. Furthermore, the medical image P is loaded from the inserted movable storage media D.

In this image transfer device 1, when instructions for a transfer are issued, the written information acquisition part 11 acquires the operating device information e63 and the account e93 from the written information storage part 12, and acquires the operation date/time information e53 from the clock part 13. As transfer historical information Ie, the writing part 12 attaches the information acquired by the written information acquisition part 11 and attaches the transfer classification information e73 and the transfer destination device information e83 received along with the transfer instruction, to a medical image P that is a subject of transfer instruction stored in the image storage part 14.

The medical image P attached with transfer historical information Ie is sent out to the network transferring part 15 or to the movable storage media reading and writing part 16 depending on the content of the transfer instruction. The network transferring part 15 transfers a medical image P attached with transfer historical information Ie to other devices through the network N, and the movable storage media reading and writing part 16 outputs a medical image P attached with the transfer historical information Ie to a movable storage media D.

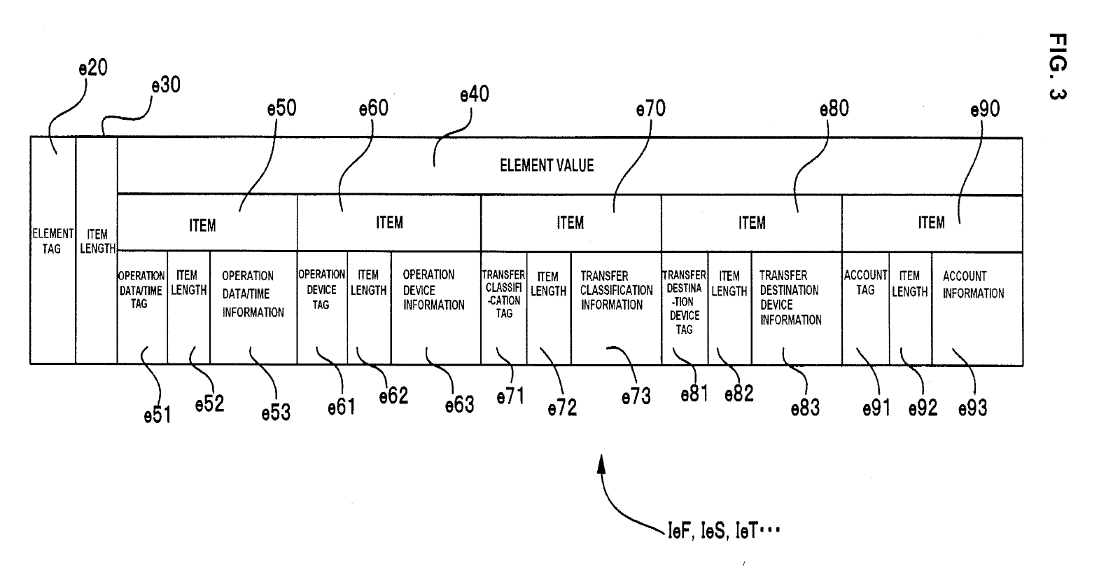

FIG. 3 is a figure showing transfer historical information Ie to be attached to a medical information P by the writing part 11. When the transfer historical information Ie is attached to a medical image, the writing part 11 writes an element tag e20 indicating the fact that it is transfer historical information Ie and an item length e30 showing the data length of the transfer historical information Ie, and writes a following element value e40 including each item e50, e60, e70, e80, e90 consisting of the transfer historical information Ie.

Into each item e50, e60, e70, e80, e90 respectively, element values e40 such as operation date/time information e53, operating device information e63, transfer classification information e73, transfer destination device information e83, account e93, and the like are to be written.

Furthermore, into each e50, e60, e70, e80, e90, as information to identify the contents of information to be written, item length e52 showing the data length of an operation date/time tag e51 and operation date/time information e53, item length e63 showing the data length of an operating device tag e61 and operating device information e63, item length e72 showing the data length of a transfer classification tag e71 and transfer classification information e73, item length e82 showing the data length of a transfer destination device tag e81 and transfer destination device information e83, and item length e92 showing the data length of an account tag e91 and an account e93, are to be written.

The operation date/time information e53 is a date/time that the written information acquisition part 11 has acquired from the clock part 13, when instructions for the transfer have been issued.

The operating device information e63 is, for example, an IP address or a device name, and is acquired from the written information storage part 12 by the written information acquisition part 11. When an operator of the device issues instructions for a transfer by directly operating the image transfer device 1, the operating device information e63 is the IP address or the device name of the image transfer device 1, that has been already stored in the written information storage 12. When the image transfer device 1 is functioning as a server on the network, the operating device information e63 is the IP address or the device name of the client device, that has been collected when logged on to the image transfer device 1 and stored in the written information storage part 12.

The transfer classification information e73 is information showing a network transfer for a transfer to other devices capable of data communication through a network, or information showing an output to a movable storage media D. When the operator of the device issues instructions for a transfer by directly operating the image transfer device 1, the transfer classification information e73 is acquired by the writing part 11 as a result of receiving a signal instructing the transfer method output from an input device. When an image transfer device 1 is functioning as a server on the network, the transfer classification information e73 is sent from a client device as transfer instruction information and is acquired by the writing part 11.

The transfer destination device information e83 is information showing a device to be transferred to, that is sent from the client device as transfer instruction information, and is acquired by the writing part 11. When sending a medical image P to other devices on the network transferring through the network, the acquisition is made by the writing part 11.

The account e93 is the user ID or the user name of an operator using the image transfer device 1, and is acquired from the written information storage part 12 by the written information acquisition part 11. When the image transfer device 1 is functioning as a server on the network, the account e93 is collected when logged on to the image transfer device 1 and is stored in the written information storage part 12.

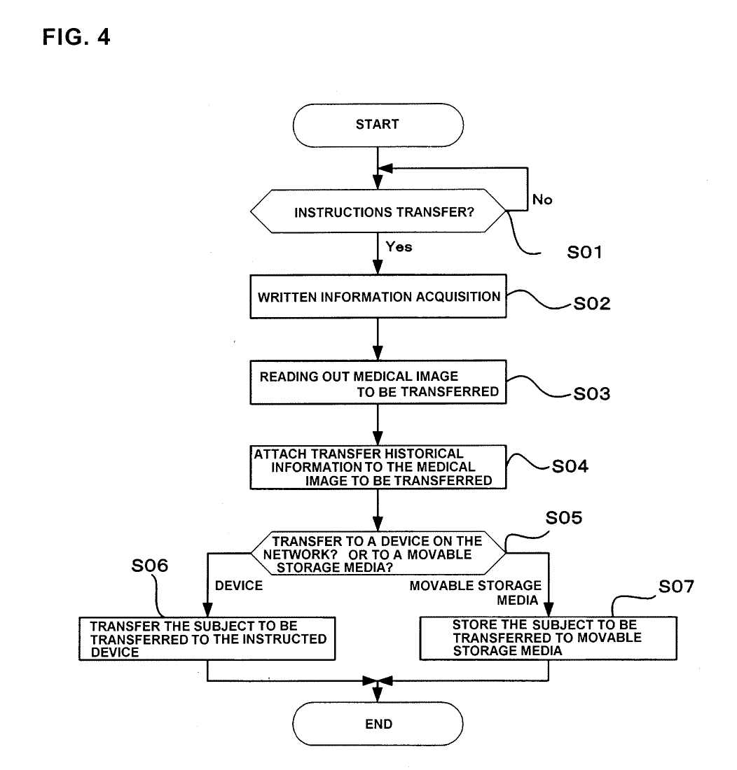

FIG. 4 is a flow chart showing a transfer process of an image transfer device 1. When instructions for a transfer of a medical image P are issued (S01, Yes), the image transfer device 1 acquires the transfer historical information Ie to be attached to the medical image P (S02).

The writing part 10 acquires operation date/time information e53 from the clock part 13, and acquires operating device information e63 and the account e93 from the written information storage part 12. When the transfer instruction is analyzed, if the transfer content is a network transfer, transfer classification information e73 indicating the fact that it is a network transfer is generated and the transfer destination device information e83 showing a device to be transferred to is acquired. When the transfer instruction is analyzed, and if the transfer content is an output to a movable storage media D, the transfer classification information e73 indicating an output to the movable storage media D is generated.

Next, a medical image P to be transferred, that is included in the transfer instruction is read out from the image storage part 14 (S03), and all information acquired in S02 is written into incidental information PI as transfer historical information Ie to be attached to the medical image P (S04). In cases where past transfer historical information Ie already exists, a subsequent addition is made following the past transfer historical information Ie.

As a result of analyzing the content of the transfer instruction, in the event that the transfer destination is other devices on the network (S05, device), the medical image P attached with the transfer historical information Ie is transferred to a device through the network to be transferred to (S06). As a result of analyzing the content of the transfer instruction, in the event that the transfer destination is movable storage media D (S05, movable storage media), the medical image P attached with the transfer historical information Ie is output to a movable storage media D that has been inserted into the movable storage media reading and writing device 16 (S07).

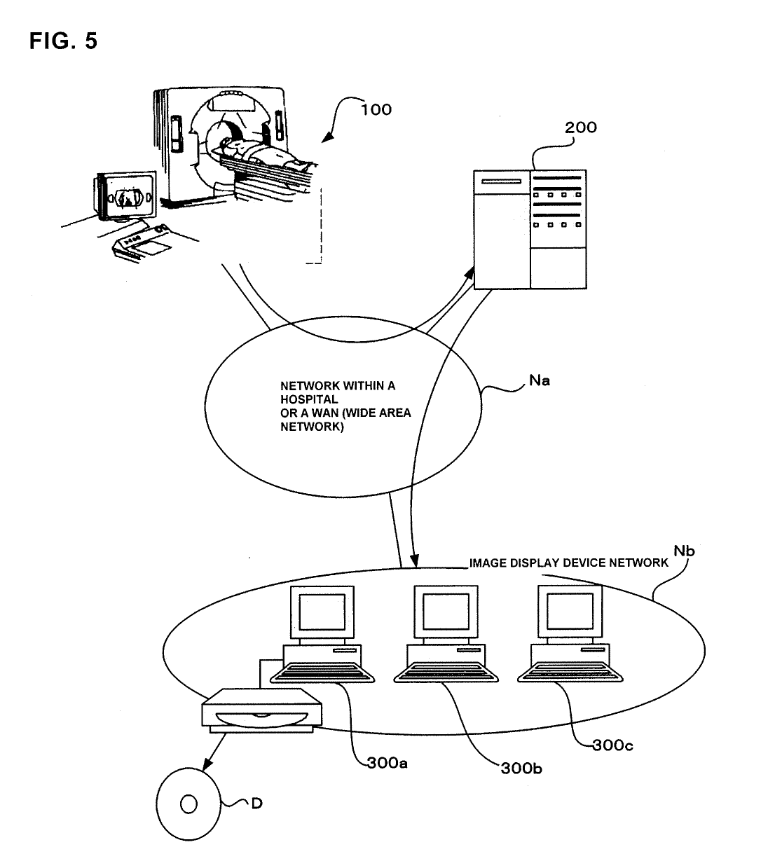

FIG. 5 is a figure showing one example of a network within a hospital in which the image transfer device 1 of the present embodiment has been incorporated. In the network Na within the hospital shown in FIG. 5, an image diagnostic device 100, image management server 200, and image display devices 300a, 300b, 300c, and so forth (hereinafter simply referred as “image display device 300” if there is no need to specify) on an image display network Nb are connected. The image diagnostic device 100, the image management server 200, and the image display device 300 respectively are provided with an image transfer device 1.

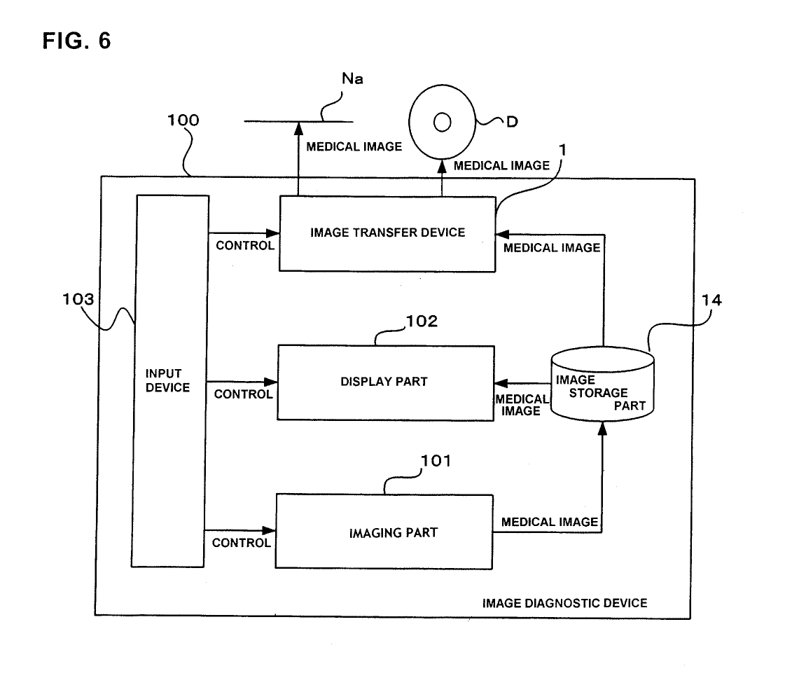

FIG. 6 is a block diagram showing an image diagnostic device 100 provided with an image transfer device 1. The image diagnostic device 100 is a device such as an X-ray diagnostic device, CT device, MRI device, and a supersonic diagnostic device for creating a medical image P by imaging the inside of a subject to be examined. The image diagnostic device 100 comprises an imaging part 101 for imaging a medical image P, an image storage part 14 for storing the imaged medical image P, a display control part 102 for displaying the imaged medical image P on a monitor, an input device 103 to be operated by an operator of the device, and an image transfer device 1. The image storage part 14 is shared by the image transfer device 1.

The image diagnostic device 100 uses the input device 103 to have an account e93 of the operator of the device input when logged on, that is stored in the written information storage part 12 provided with the image transfer device 1. Furthermore, the imaging part 101, display control part 102, or image transfer device 1 is controlled, depending on the operation of the input device 103. When a transfer of a medical image P is issued instructions using the input device 103, the image transfer device 1 is controlled.

The image transfer device 1: reads out device information e63 showing the image diagnostic device 100 and the account e93 input when logged in from the written information storage part 12; reads out the operation date/time information e53 from the clock part 13; generates transfer classification information e73 and transfer destination device information e83 from the transfer instructional content; and attaches such information to a medical image P that has been read out from the image storage part 14 to be transferred as transfer historical information Ie. Once the transfer historical information Ie is attached, the medical image P is transferred to the transfer destination. If the transfer classification is a network transfer, the transfer is made out to a network Na, and if the transfer classification is an output to a movable storage media D, writing to a movable storage media that has been inserted to the movable storage media reading and writing device 16 takes place.

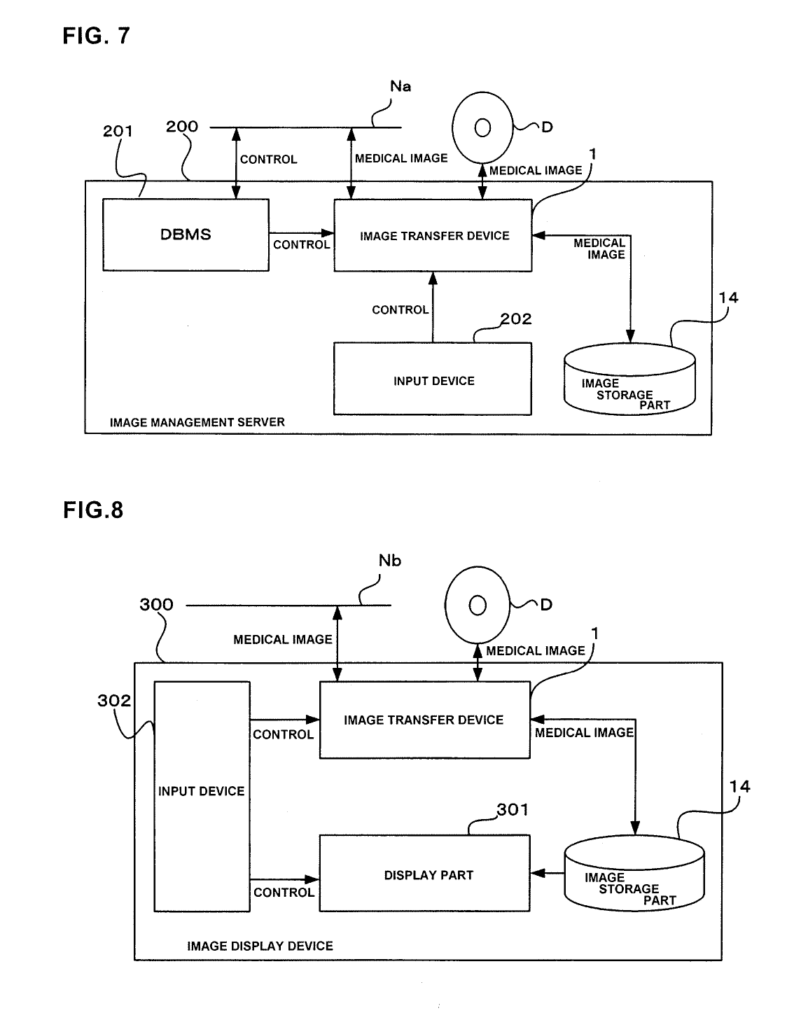

FIG. 7 is a block diagram showing an image management server 200 provided with an image transfer device 1. The image management server 200 is a file server that manages medical images P created by the image diagnostic device 100 by compiling them into a database, searches a medical image P responding to a request of a client device such as an image display device 300, and transfers the corresponding medical image P. The image management server 200 compiles medical images P into a database and comprises DBMS (database management system) 201 for managing, an image storage part 14 for storing medical images P, an input device 202 to be operated by an operator of the device, and an image transfer device 1. The image storage part 14 is shared by the image transfer device 1.

The image management server 200 uses a client device to have an account e93 of the operator of the device who is trying to log-in input, that is stored in the written information storage part 12 provided with the image transfer device 1. Furthermore, responding to the request from the client device, a DBMS201 or an image transfer device 1 is controlled. If the content of the request is a transfer process of a medical image P, the image transfer device 1 is controlled.

The image transfer device 1: reads out device information e63 showing the client device being logged in and the account e93 input when logged in from the written information storage part 12; reads out the date/time information e53 from the clock part 13; generates transfer destination device information e83 and transfer classification information e73 from the transfer request content; and attaches such information to a medical image P that has been read out from the image storage part 14 to be transferred as transfer historical information Ie. Once the transfer historical information Ie is attached, the medical image P is transferred to the transfer destination. If the transfer classification is a network transfer, the transfer is made out to a network Na, and if the transfer classification is an output to a movable storage media D, writing to a movable storage media that has been inserted to the movable storage media reading and writing device 16 takes place.

FIG. 8 is a block diagram showing an image display device 300 provided with an image transfer device 1. The image display device 300 is a device to display medical images P. The image display device 300 comprises a display control part 301 for displaying medical images P on a monitor, an image storage part 14 for temporarily saving a medical image P, an input device 302 to be operated by the operator of the device, and an image transfer device 1. The image storage part 14 is shared by means of the image transfer device 1.

The image display device 300 uses an input device 103 to have an account e93 of the operator of the device input when logged in, that is stored in the written information storage part 12 provided with the image transfer device 1. Furthermore, in accordance with the operation of the input device 302, the display control part 301 and the image transfer device 1 are controlled. When instructions for a transfer of a medical image P are issued using the input device 103, the image transfer device 1 is controlled. Furthermore, when a medical image P is displayed, the image display device 300 has a medical image P that has been transferred through a network or a medical image P stored in a movable storage media D stored in the image storage part 14 through the image transfer device 1. The display control part 301 reads out a medical image P stored in the image storage part 14 to be displayed on a monitor.

The image transfer device 1: reads out device information e63 showing the image display device 300 and the account e93 input when logged in from the written information storage part 12; reads out date/time information e53 from the clock part 13; generates transfer classification information e73 and transfer destination device information e83 from the transfer instructional content; and attaches such information to a medical image P that has been read out from the image storage part 14 to be transferred as transfer historical information Ie. Once the transfer historical information Ie is attached, the medical image P is transferred to the transfer destination. If the transfer classification is a network transfer, the transfer is made to a network Na, and if the transfer classification is an output to a movable storage media, writing to the inserted movable storage media by the movable storage media reading and writing device 16 will take place.

In such a network Na within a hospital, the data structure of a medical image P managed by the image management server 200 is described.

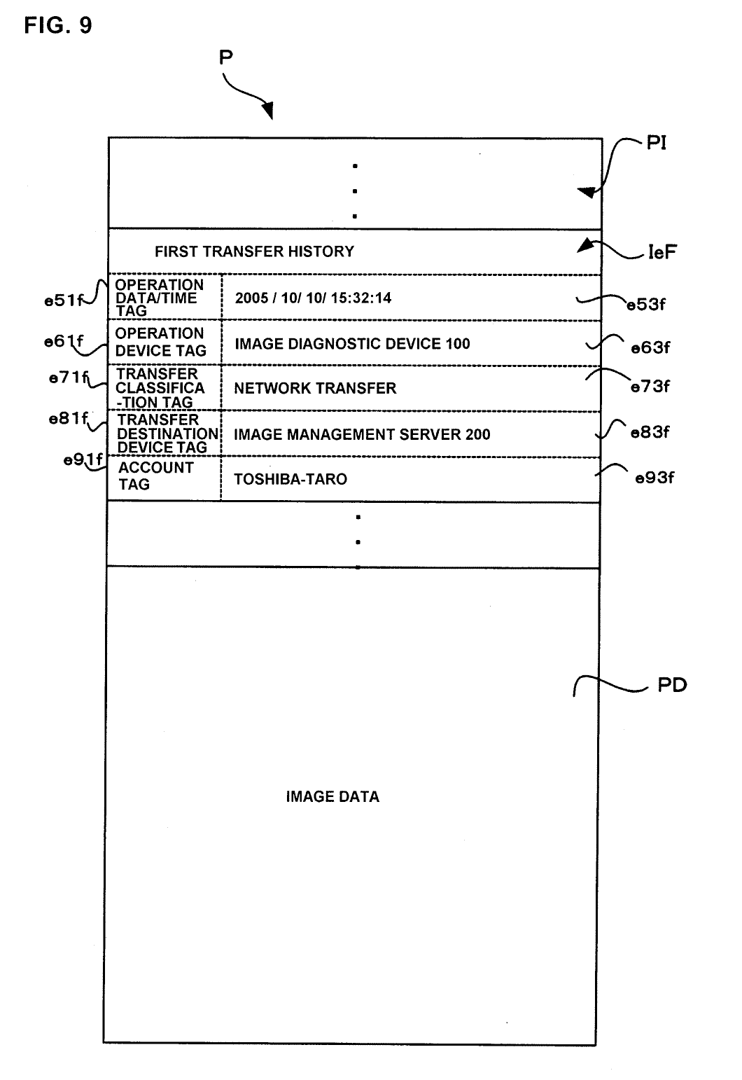

FIG. 9 is a figure showing the data structure of a medical image managed by the image management server 200. Medical images P being managed in the image management server 200 are those that have been created by an image diagnostic device 100 and transferred via a network transfer or a movable storage media D.

As shown in FIG. 9, transfer historical information IeF showing the transfer having been made from the image diagnostic device 100 is attached to a medical image P being managed by the image management server 200. In the transfer historical information IeF, corresponding to an operation date/time tag e51f, for example, the operation date/time information e53f showing that the transfer was made at “15:32:14, Oct. 10, 2005” is written. Furthermore, corresponding to an operating device tag e61f, operating device information e63f showing that the transfer was made from the image diagnostic device 100 is written. Corresponding to a transfer classification tag e71f, for example, transfer classification information e73f showing that the transfer was made through the network is written. Corresponding to a transfer destination device tag e81f, for example, transfer destination device information e83f showing that the transfer was made to the image management server 200 is written. Corresponding to an account tag e91f, for example, an account e93f showing “TOSHIBA_TARO” who has operated the image diagnostic device 100 and given a transfer instruction is written.

If this medical image P is leaked, the cause of the leak can be determined from the medical image P, such as the possibility of having leaked while transferring to the image management server 200, or the possibility of having transferred to a computer that was disguised as the image management server 200, identifying the person whose actions were the cause of the leak, and identifying the time range during which the leak occurred.

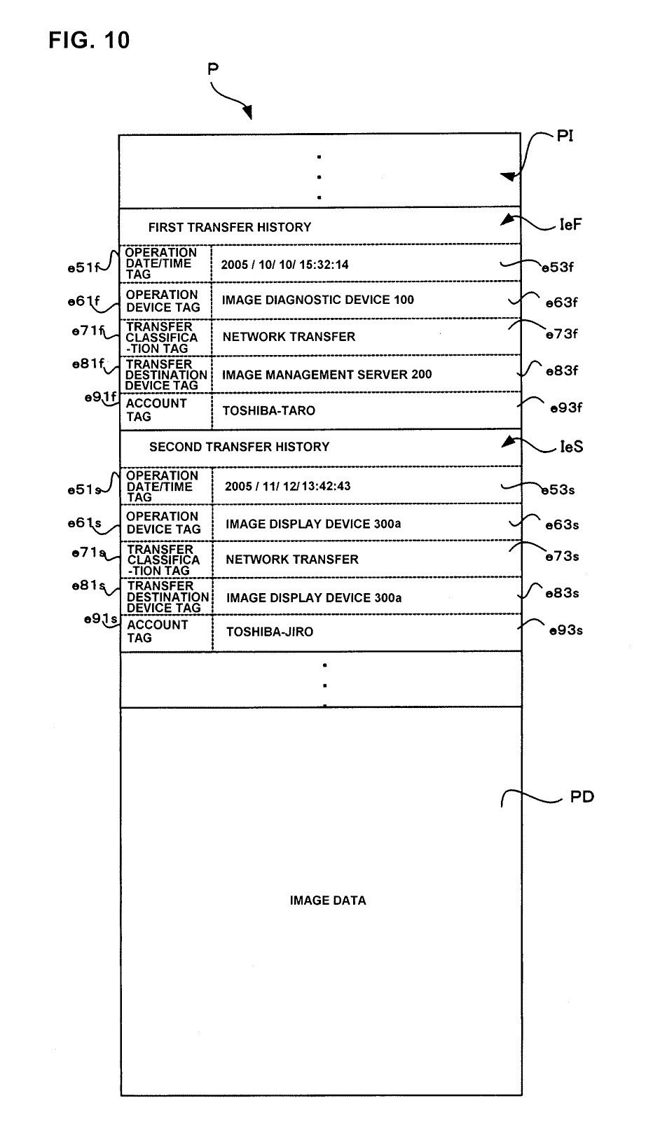

FIG. 10 is a figure showing the data structure of a medical image P transferred to the image display device 200. Medical images P transferred to an image display device 300 are those that have been created by an image diagnostic device 100 and transferred via a network transfer or a movable storage media D to the image management server 200.

As shown in FIG. 10, transfer historical information IeF has been attached to a medical image P managed by the image display device 300 showing that the transfer was made from the image diagnostic device 100 to the image management server 200. Furthermore, transfer historical information IeS has been added showing that a transfer was made from the image management server 200 to the image display device 300.

In the transfer historical information IeS, corresponding to an operation date/time tag e51s, for example, operation date/time information e53s showing that the transfer was made at “13:42:43 on Oct. 12, 2005” is written. Furthermore, corresponding to an operating device tag e61s, for example, operating device information e63s showing that the transfer operation was conducted by logging into the image management server 200 from an image display device 300a is written. Corresponding to a transfer classification tag e71s, for example, transfer classification information e73s showing that the transfer was made through the network is written. Corresponding to a transfer destination device tag e81s, for example, transfer destination device information e83s showing that the transfer was made to the image display device 300a is written. Corresponding to an account tag e91s, for example, an account e93f showing “TOSHIBA_JIRO” who has operated the image management server 200 and given a transfer instruction is written.

If this medical image P is leaked, the cause of the leak may be determined from the medical image P, such as the possibility of having leaked while transferring to the image display device 300a, or the possibility of having transferred to a computer that was disguised as the image display device 300a, identifying the person whose actions were the cause of the leak, and identifying the time range during which the leak occurred.

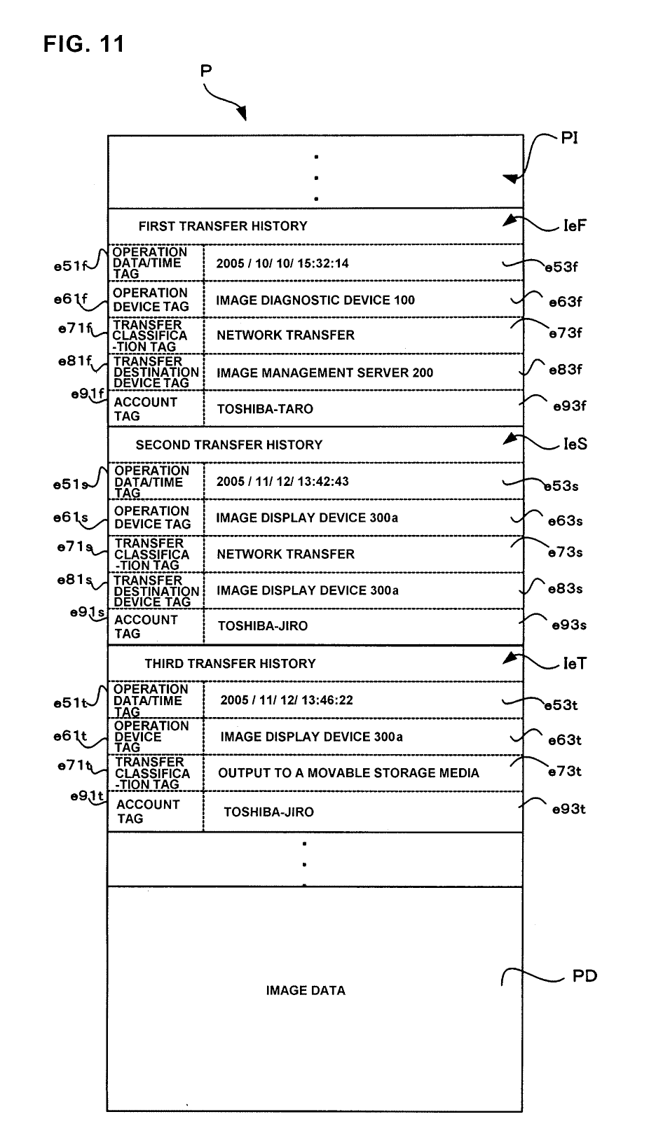

FIG. 11 is a figure showing the data structure of a medical image output from the image diagnostic device 300a to a movable storage media D. Medical images P output to a movable storage media D are those that have been created by an image diagnostic device 100, further transferred via a network transfer or a movable storage media D to the image management server 200, and output to the movable storage media D in the image display device 300a.

As shown in FIG. 11, transfer historical information IeF showing that the transfer was made from the image diagnostic device 100 to the image management server 200 and transfer historical information IeS showing that the transfer was made by the image display device 300a accessing the image management server 200, has been attached to a medical image P stored in the movable storage media D. Furthermore, transfer historical information IeT has been added showing that an output was made from the image display device 300a to the movable storage media D.

In the transfer historical information IeT, corresponding to an operation date/time tag e51t, for example, operation date/time information e53t showing that the transfer was made at “13:46:22 on Oct. 12, 2005” is written. Furthermore, corresponding to an operating device tag e61t, for example, an operating device information e63t showing that the transfer was instructed from the image display device 300a is written. Corresponding to a transfer classification tag e71t, transfer classification information e73t showing, for example, that the output was made out to a movable storage media D is written. Corresponding to an account tag e91s, for example, an account e93f showing “TOSHIBA_JIRO” who has operated the image display device 300a to output to the movable storage media D is written.

In the event that this medical image P is leaked, the cause of the leak can be determined from the medical image P, such as the possibility of having been leaked by the movable storage media D itself, a person's handling of data being the cause of a leak, and the time of the leak.

As described above, when a medical image P is transferred, the image transfer device 1 of the present embodiment attaches transfer historical information Ie to the medical image P to be transferred. In the event that a medical image P is leaked, the route of leakage may be identified easily by analyzing the transfer historical information Ie attached to the leaked medical image P, and prompt handling including setting up recurrence prevention measures can be determined.

What is claimed is:

1. An image transfer device comprising:
a writing device attaching historical information for a transfer or recording corresponding to instructional content for transfer or recording to a medical image to be transferred or recorded, when instructions for the transfer or recording of a medical image to other media are issued, and
a transfer device transferring or recording a medical image with attached said historical information to other media.

2. An image transfer device according to claim 1, wherein:
said writing device adds said historical information corresponding to said instructional content when said historical information in the past has been attached.

3. An image transfer device according to claim 1, wherein:
said historical information includes the date and/or time of a transfer or recording, as well as the operator's account and operational device information.

4. An image transfer device according to claim 1, wherein:
said historical information includes the date and/or time of a transfer or recording, the operator's account, operational device information, and transfer classification information, and
said transfer classification information records a network transfer.

5. An image transfer device according to claim 1, wherein:
said historical information includes the date and/or time of a transfer or recording, the operator's account, operational device information, and transfer classification information, and
said transfer classification information indicates the output to a movable storage media.

6. An image diagnostic device comprising:
an imaging device obtaining a medical image,
a writing device for attaching the historical information for a transfer or recording corresponding to instructional content of the transfer or recording to medical images to be transferred or recorded, when instructions for the transfer or recording of the obtained medical image to other media are issued, and
a transfer device transferring or recording a medical image with attached said historical information to other media.

7. An image management server comprising:
a storage device storing medical images,
a writing device for attaching a historical information for a transfer or recording corresponding to an instructional content of a transfer or recording to medical images to be transferred or recorded, when instructions for the transfer or recording of the stored medical image to other media are designated, and
a transfer device transferring a medical image with attached said historical information to other media.

8. An image display device comprising:
an acquisition device acquiring a medical image from other media,
a display control device controlling the display of the acquired medical image,
a writing device attaching the historical information for a transfer or recording corresponding to the instructional content of a transfer or recording to medical images to be transferred or recorded, when instructions for the transfer or recording of the acquired medical image to other media are designated, and
a transfer device for transferring a medical image with attached said historical information to other media.

9. An image diagnostic device according to claim 6, wherein:
said historical information includes the date and/or time of transfer or recording, the operator's account and operational device information.

10. An image diagnostic device according to claim 6, wherein:
said historical information includes the ate and/or time of a transfer or recording, the operator's account, operational device information, and transfer classification information, and
said transfer classification information records a network transfer.

11. An image diagnostic device according to claim 6, wherein:
said historical information includes the date and/or time of transfer or recording, the operator's account, operational device information, and transfer classification information, and
said transfer classification information records the output to a movable storage.

12. An image management server according to claim 7, wherein:
said historical information includes the date and/or time of a transfer or recording, the operator's account and operational device information.

13. An image management server according to claim 7, wherein:
said historical information includes the date and/or time of a transfer or recording, the operator's account, operational device information, and transfer classification information, and
said transfer classification information records a network transfer.

14. An image management server according to claim 7, wherein:
said historical information includes the date and/or time of a transfer or recording, the operator's account, operational device information, and transfer classification information, and
said transfer classification information records the output to a movable storage.

15. An image display device according to claim 8, wherein:
said historical information includes the date and/or time of a transfer or recording, the operator's account and operational device information.

16. An image display device according to claim 8, wherein:
said historical information includes the date and/or time of transfer or recording, the operator's account, operational device information, and transfer classification information, and
said transfer classification information records a network transfer.

17. An image display device according to claim 8, wherein:
said historical information includes the date and/or time of a transfer or recording, the operator's account, operational device information, and transfer classification information, and
said transfer classification information records ate output to a movable storage.
